(19) United States
(12) Patent Application Publication
(10) Pub. No.: US 2005/0048310 A1
(43) Pub. Date: Mar. 3, 2005

(54) Organic electroluminescent device based upon emission of exciplexes or electroplexes, and a method for its fabrication

(75) Inventors: Massimo Cocchi, Bologna (IT); Gabriele Giro, Bologna (IT); Valeria Fattori, Bologna (IT); Piergiulio Di Marco, Bologna (IT); Jan Kalinowski, Gdynia (PL)

Correspondence Address: Darby & Darby, 805 Third Avenue, New York, NY, 10022-7513, US

(73) Assignee: Consiglio Nazionale Delle Ricerche, Roma (IT)

(21) Appl. No.: 10/483,893

(22) PCT Filed: Jul. 12, 2002
(86) PCT No.: PCT/IT02/00458

(30) Foreign Application Priority Data
Jul. 13, 2001 (IT) T02001A000692

(51) Int. Cl. H05B 33/14

(52) U.S. Cl. 428/690; 428/917; 428/212; 313/504; 313/506; 427/66

(57) ABSTRACT

An organic electroluminescent device (1) based upon emission of exciplexes or electroplexes, the device basically including an anode (2), a cathode (3), a first layer (4), which comprises organic material for transporting positive charges (5), and a second layer (6), which comprises organic material for transporting negative charges (7), said organic material for transporting negative charges (7) and said organic material for transporting positive charges (5) being capable to form between them exciplexes or electroplexes.

### TECHNICAL FIELD

The present invention relates to an organic electroluminescent device based upon emission of exciplexes or electroplexes with high emission efficiency.

### BACKGROUND ART

In the field of organic electroluminescent devices (OLEDs) there have recently been proposed organic electroluminescent devices that use exciplexes, which are formed by a material for transporting negative charges and by a material for transporting positive charges, for the emission of light radiation. In particular, the use is known of electroluminescent devices comprising an anode and a cathode, between which is set an intermediate layer of organic material, which comprises a mixture of the organic material for transporting positive charges and of the organic material for transporting negative charges. Although further embodiments of this type of devices envisage the insertion of further layers of organic material, the presence of the intermediate layer, inside which the exciplexes are formed, has always been considered essential for the functioning of this type of OLEDs.

The presence of the mixed intermediate layer, between the anode and the cathode renders devices of this type costly and difficult to manufacture, in particular, in view of the fact that the intermediate layer is usually obtained by means of a relatively complex and somewhat difficult operation, namely a simultaneous sublimation of two substances having physico-chemical characteristics that are different from one another.

### DISCLOSURE OF INVENTION

The purpose of the present invention is to provide an organic electroluminescent device, which is free from the drawbacks described above and is, hence, easy and inexpensive to manufacture.

According to the present invention, there is provided an organic electroluminescent device based upon emission of exciplexes or electroplexes, the organic electroluminescent device essentially including an anode, a cathode, a first layer, which comprises at least one organic material for transporting positive charges and is set in contact with the anode, and a second layer, which comprises at least one organic material for transporting negative charges and is set in contact with said cathode and with said first layer, said organic material for transporting negative charges and said organic material for transporting positive charges being capable to form between them exciplexes or electroplexes.

Here and in the ensuing text, the expression “essentially including” does not mean that the organic electroluminescent device cannot include other constituents, but means that there is not present between the anode and the cathode a layer that comprises a mixture of the organic material for transporting negative charges and of the organic material for transporting positive charges.

In the device defined above, it is possible that leakage currents will be created, which do not contribute to the emission of the electromagnetic radiation and are due, above all, to positive currents (i.e., a transfer of holes between adjacent molecules) that start from the anode, traverse the first and the second layer, and discharge at the cathode. The passage of charge between the first and second layers occurs as a consequence of an electron jump from the HOMO of the organic material for transporting negative charges to the HOMO (in which an hole is present) of the organic material for transporting positive charges. These currents, in addition to diminishing the efficiency of the OLED, raise the temperature, causing morphological alterations of the first layer and of the second layer, with consequent damage to the device.

For the above reason, preferably, said organic material for transporting negative charges has a first ionization potential and said organic material for transporting positive charges has a second ionization potential, the first ionization potential being higher by at least 0.7 electronvolts than the second ionization potential.

Furthermore, it is possible, albeit with relatively less likelihood, that leakage currents will be created, which do not contribute to the emission of the electromagnetic radiation and are due above all to negative currents (i.e., passage of electrons between adjacent molecules) that start from the cathode, traverse the second and first layers, and discharge at the anode. The passage of charge between the second and first layers occurs, in this case, as a consequence of an electron jump from the LUMO of the organic material for transporting negative charges to the LUMO of the organic material for transporting positive charges.

Also the negative currents, in addition to diminishing the efficiency of the OLED, raise the temperature, causing morphological alterations of the first and second layers, with consequent damage to the device.

Consequently, according to a preferred embodiment, said organic material for transporting negative charges has a first electronic affinity and said organic material for transporting positive charges has a second electronic affinity, the first electronic affinity being higher by at least 0.4 electronvolts than the second electronic affinity.

The present invention moreover relates to a method for the fabrication of an organic electroluminescent device.

According to the present invention, a method is provided for the fabrication of an organic electroluminescent device based upon emission of exciplexes or electroplexes, the method basically including the steps of: depositing on an anode a first layer comprising at least one organic material for transporting positive charges; depositing on said first layer a second layer comprising an organic material for transporting negative charges; and positioning on said second layer a cathode, the organic material for transporting negative charges and the organic material for transporting positive charges being capable to form between them exciplexes or electroplexes.

### BRIEF DESCRIPTION OF THE DRAWINGS

The invention will now be described with reference to the annexed drawings, which illustrate some non-limiting examples of embodiment, in which:

FIG. 1 is a cross section of a first embodiment of the device according to the present invention;

FIG. 2 is a perspective view, with parts removed for reasons of clarity, of a detail of a second embodiment of the device according to the present invention;

FIG. 3 illustrates a spectrum of emission of a device built according to Example 1;

FIG. 4 is an experimental graph representing the function intensity of electroluminescence vs. applied voltage, and the function current density vs. applied voltage of a device built according to Example 1; and

FIG. 5 is an experimental graph representing the function efficiency of a device vs. applied voltage of a device built according to Example 1.

### BEST MODE FOR CARRYING OUT THE INVENTION

With reference to FIG. 1, the number 1 designates as a whole an organic electroluminescent device comprising an anode 2 and a cathode 3 that are separated from one another by a layer 4 of an organic material for transporting positive charges 5 and by a layer 6 of an organic material for transporting negative charges 7, which are in contact with one another, but substantially completely separated. The organic material for transporting positive charges 5 is capable to combine with the organic material for transporting negative charges 7 so as to form exciplexes or electroplexes, which, by decaying from one of their electrically excited states, are able to emit electromagnetic radiation.

The cathode 3 and the anode 2 are connected (in a known way and here schematically illustrated) to an external current generator 8, which is designed to induce a difference of potential between the cathode 3 and the anode 2.

The layer 4 is designed to transfer holes, which are caused, in use, by the oxidative processes that occur at the anode 2, from the anode 2 towards the layer 6. The layer 4 is set in contact with the anode 2 itself and with the layer 6, so as to be positioned on the opposite side of the cathode 3 with respect to the layer 4.

The layer 6 is designed to transfer electrons coming from the cathode 3 towards the layer 4 and is set in contact with the cathode 3 and on the opposite side of the anode 2 with respect to the layer 4.

A glass substrate 9 is set on the opposite side of the layer 4 with respect to the anode 2 and provides a mechanical support to the anode 2, which has a relatively thin layer of a material with high work function, for example indium and tin oxides (ITOs). In this connection, it is important to emphasize that both the anode 2 and the glass substrate 9, since they are transparent, enable passage of light.

The cathode 3 is provided with a relatively thin layer, which is made of a material with low work function, for example calcium, and is set underneath a layer of silver 10.

In use, the current generator 8 is actuated so as to generate a difference of potential between the anode 2 and the cathode 3. The holes that are created at the anode 2 in the material for transporting positive charges 5 transfer on account of the electric field generated between the cathode 3 and the anode 2 up to an interface 11, defined by the layers 4 and 6. Likewise, the electrons transferred from the cathode to the material for transporting positive charge 7 transfer through the layer 6 as far as the interface 11.

At this point, the molecular cations of the layer 4 and the molecular anions of the layer 6 combine at the interface so as to form exciplexes or electroplexes, i.e., a combination of at least two molecules in an excited state, which decay, dissociating to form the constituent molecules and emitting electromagnetic radiation.

From what has been set forth above, it emerges that the selection of the organic materials for transporting negative charges and for transporting positive charges must be carried out with care. In particular, the organic materials for transporting positive charges 5 and the material for transporting negative charges 7 must be chosen so as to be able to form between them exciplexes or electroplexes.

In order to improve the efficiency of the organic electroluminescent device 1, it is preferable for the organic material for transporting negative charges to have the ionization potential higher by at least 0.7 electronvolts than the ionization potential of the organic material for transporting positive charges. In this way, the electrons present on the HOMO of the organic material for transporting negative charges 7, which is set at the interface 11, basically do not succeed in passing onto the HOMO of the organic material for transporting positive charges 5, which is set at the interface 11.

It is moreover preferable for the electronic affinity of the organic material for transporting negative charges 7 to be higher by at least 0.4 electronvolts than the electronic affinity of the organic material for transporting positive charges 5. In a way similar to what occurs in the case of the positive charges, in this way, the electrons coming from the cathode present on the LUMO of the material for transporting negative charges 7, which is set at the interface 11, basically fail to pass onto the LUMO of the organic material for transporting positive charges 5, which is set at the interface 11.

By so choosing the organic materials for transporting negative charges 7 and positive charges 5, leakage currents, which do not contribute to the emission of electromagnetic radiation, are substantially limited.

Preferably, the organic material for transporting negative charges 7 is selected in such a way that its electronic affinity will be relatively close to the work function of the material of which the cathode is substantially made, and the material for transporting positive charges 5 is selected in such a way that its ionization potential will be relatively close to the work function of the material of which the anode is substantially made.

The organic material for transporting positive charges 5 preferably comprises a tertiary aromatic amine which is suitable to transfer positive charges and satisfies the structural formula (I): 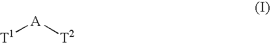
in which T¹ and T² represent, each independently of the other, a tertiary amine, and in which A represents an aryl group. By the expression “each independently of the other” is meant the fact that T¹ and T² can be identical to one another or different.

Preferably, T¹ and T² represent, each independently of the other, a tertiary amine that satisfies the structural formula (II) or the structural formula (III): 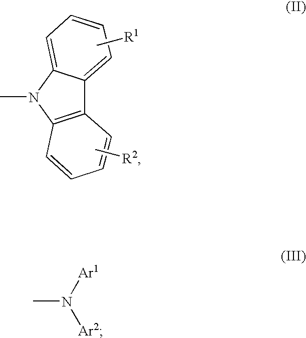
in which R¹ and R², represent, each independently of the other, an alkyl group, an alcohol group, or an atom of hydrogen; and in which Ar¹ and Ar² represent, each independently of the other, an aryl group.

Ar¹ and Ar², preferably, represent, independently of one another, a functionality that satisfies one the structural formulas (IV), (V), (VI), (VII), (VIII), (IX) or (X): 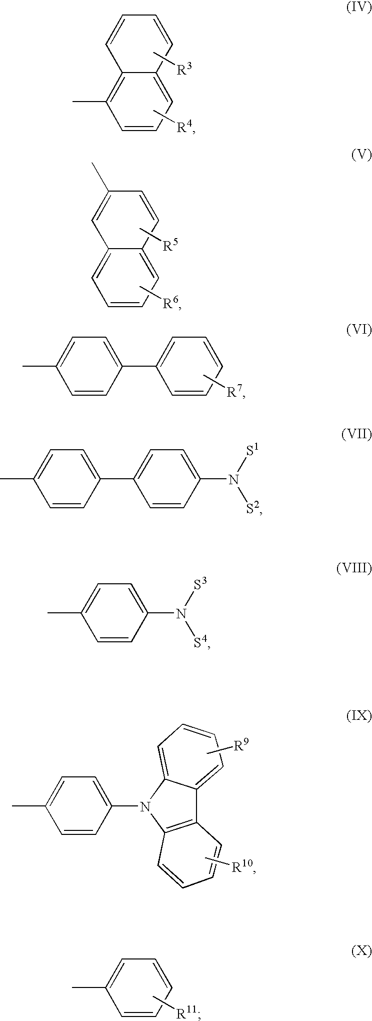
in which R³, R⁴, R⁵, R⁶, R⁷, R⁹, R¹⁰ and R¹¹ represent, each independently of the others, an alkyl group, an alcohol group, or an atom of hydrogen, and in which S¹, S², S³ and S⁴ represent, each independently of the others, the functionality (XI), (XII), (XIII), or (XIV): 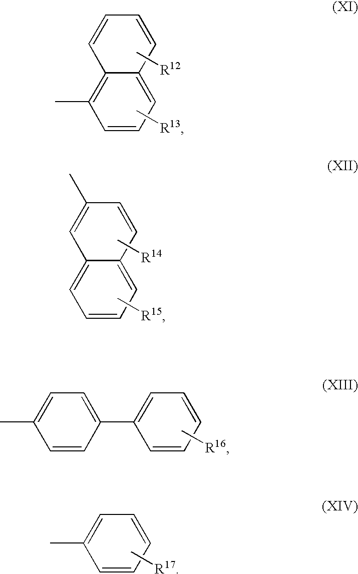
in which R¹², R¹³, R¹⁴, R¹⁵, R¹⁶, and R¹⁷ represent, each independently of the others, an alkyl group, an alcohol group, or an atom of hydrogen.

The organic material for transporting negative charges 7 comprises, preferably, an oxidiazole that satisfies the structural formula (XV) or a triazole that satisfies the structural formula (XVI): 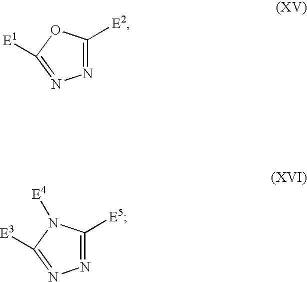
in which E¹, E², E³, E⁴ and E⁵ are, each independently of the others, an aryl group.

E¹, E², E³, E⁴ and E⁵ preferably represent, each independently of the others, a substituent that satisfies the structural formula (XVII), (XVIII), (XIX), (XX), (XXI), (XXII), (XXIII), (XXIV), (XXV), (XXVI), or (XXVII): 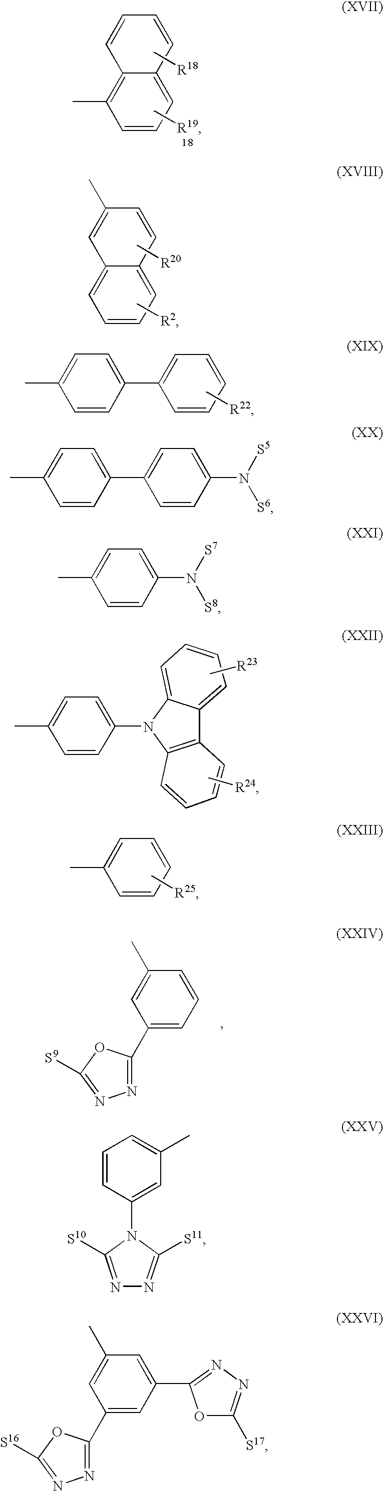 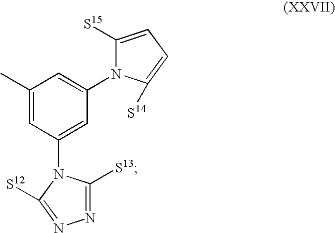
in which R¹⁸, R¹⁹, R²⁰, R²¹, R²², R²³, R²⁴, and R²⁵ represent, each independently of the others, an alkyl group, an alcohol group, or an atom of hydrogen, and in which S⁵, S⁶, S⁷, S⁸, S⁹, S¹⁰ S¹¹, S¹², S¹³, S¹⁴, S¹⁵, S¹⁶ and S¹⁷ represent, each independently of the others, a functionality that satisfies the structural formula (XXVIII), (XXIX), (XXX), or (XXXI): 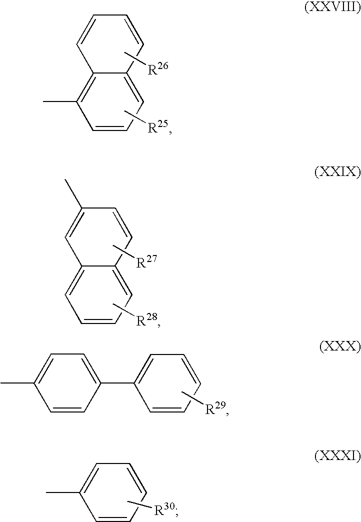
in which R²⁵, R²⁶, R²⁷, R²⁸, R²⁹, and R³⁰ represent, each independently of the others, an alkyl group, an alcohol group, or an atom of hydrogen.

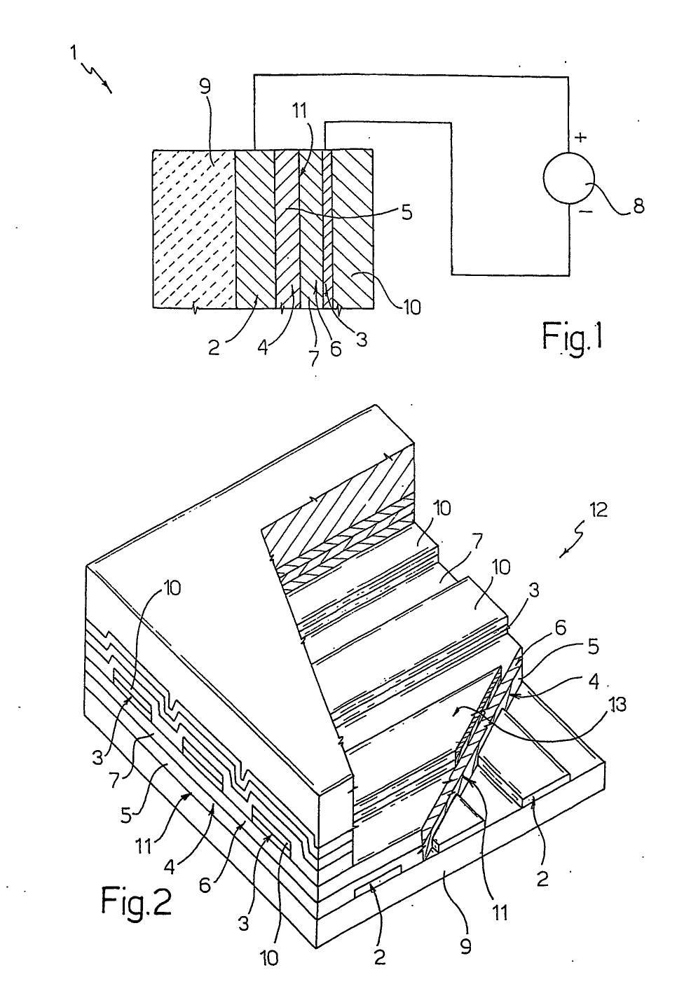

The variant illustrated in FIG. 2 relates to an organic electroluminescent device 12 similar to the device 1 and the parts of which are designated by the same reference numbers that designate the corresponding parts of the control device 1.

The device 12 differs from the device 1 substantially in that, in the device 12, there are present a plurality of anodes 2 and of cathodes 3 having the shape of a parallelepiped with a rectangular base, the cathodes 3 lying on a plane that is different from and parallel to the plane on which the anodes 2 lie. The layers 4 and 6 are set between the two planes. The longitudinal axes of the cathodes 3 are parallel to one another and transverse to the longitudinal axes of the anodes 2. In this way, the cathodes 3, by being set on top of the anodes 2, define a plurality of areas 13, each of which can light up individually and independently of the others.

Further characteristics of the present invention will emerge from the ensuing description of some non-limiting examples of the organic electroluminescent device 1.

### EXAMPLE 1

An organic electroluminescent device was prepared in the following way.

A plate of glass coated with a layer of indium and tin oxide, which has a thickness of approximately 100 nm and is substantially transparent, was cleaned by being dipped in a boiling solution of acetone and alcohol and subsequently being put into an ultrasound washer for approximately thirty minutes.

At this point, the following layers were deposited, in succession, one on top of the other, by sublimation in an high-vacuum evaporator and at a pressure of 8×10^{□4} Pa, on the coated glass plate: a layer of 4,4′,4″-tri(N,N-diphenyl-amino)-triphenylamine (TDATA) of a thickness of 60 nm; a layer of a thickness of 60 nm of 3-(4-diphenylyl)-4-phenyl-5-ter-butylphenyl-1,2,4-triazole (PBD); a layer of calcium of a thickness of 25 nm; and a layer of silver of a thickness of 100 nm.

Note that the ionization potential and the electronic affinity of TDATA are substantially between 5 eV and 5.1 eV and 1.5 eV and 1.9 eV, respectively. The ionization potential and the electronic affinity of PBD are approximately 6.3 eV and 2.8 eV, respectively. Consequently, in absolute value, the differences between the potentials of ionization and between the electronic affinities of TDATA and of PBD are approximately 1.2 eV and 1.1 eV, respectively.

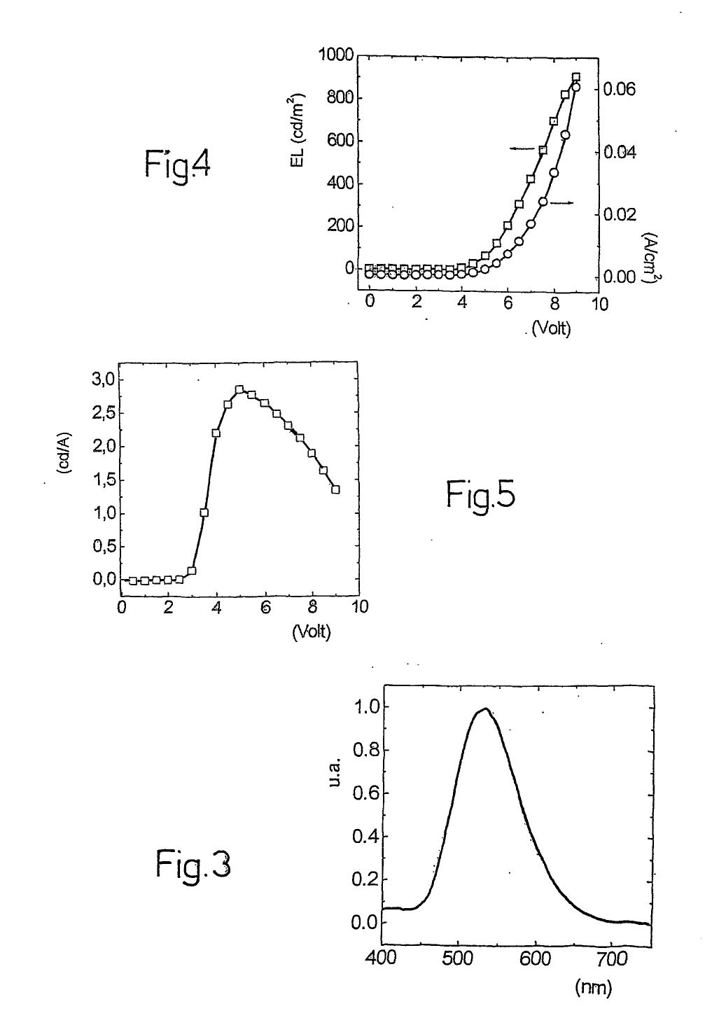

The device thus obtained, which has an active surface of 0.07 cm², was tested under laboratory conditions (i.e., with a temperature of between 20° C. and 24° C. and with a humidity of between 55% and 65%) and revealed an electromagnetic emission in the green having a spectrum as is illustrated in FIG. 3. The curves that are obtained experimentally from the use of said device and which represent the intensity of electroluminescence and the current density as a function of the voltage applied are illustrated in FIG. 4. The curve that is experimentally obtained from the use of said device representing the efficiency as a function of the applied voltage is illustrated in FIG. 5.

### EXAMPLE 2

An organic electroluminescent device was prepared in a substantially identical way as the organic electroluminescent device of Example 1, except for the fact that, instead of the layer of TDATA, a layer of 4,4′,4″-tri(carbazol-9-yl)-triphenylamine (TCTA) was deposited.

Note that the ionization potential and the electronic affinity of TCTA are approximately equal to 5.6 eV and 2.3-1.9 eV, respectively. The ionization potential and the electronic affinity of PBD are approximately 6.3 eV and 2.8 eV, respectively. Consequently, in absolute value, the differences between the potentials of ionization and between the electronic affinities of TCTA and PBD are approximately 0.7 eV and 0.5 eV, respectively.

The device thus obtained, which has an active surface of 0.07 cm², was tested under laboratory conditions (i.e., with a temperature of between 20° C. and 24° C. and with a humidity of between 55% and 65%) and revealed an electromagnetic emission in the blue-violet.

### EXAMPLE 3

An organic electroluminescent device was prepared in a substantially identical way as the organic electroluminescent device of Example 2 except for the fact that, instead of the layer of TCTA, there was deposited a layer of 4,4′,4″-tri(N-3-methylphenyl-N-phenyl-amino)-triphenylamine (M-TDATA). Note that the ionization potential and the electronic affinity of M-IDATA are substantially between 5 eV and 5.1 eV and 1.5 eV and 1.9 eV, respectively. The ionization potential and the electronic affinity of PBD are approximately 6.3 eV and. 2.8 eV, respectively.

Consequently, in absolute value, the differences between the potentials of ionization and between the electronic affinities of M-TDATA and of PBD are approximately 1.2 eV and 1.1 eV, respectively.

The device thus obtained, which has an active surface of 0.07 cm², was tested under laboratory conditions (i.e., with a temperature of between 20° C. and 24° C. and with a humidity of between 55% and 65%) and revealed an electromagnetic emission in the green substantially identical to the emission of Example 1.

### EXAMPLE 4

An organic electroluminescent device was prepared in a substantially identical way as the organic electroluminescent device of Example 1, except for the fact that, instead of the layer of TDATA, there was deposited a mixed layer of TDATA and polycarbonate.

The device thus obtained, which has an active surface of 0.07 cm², was tested under laboratory conditions (i.e., with a temperature of between 20° C. and 24° C. and with a humidity of between 55% and 65%) and revealed an electromagnetic emission in the green that was substantially identical to the emission of Example 1.

### EXAMPLE 5

An organic electroluminescent device was prepared in a substantially identical way as the organic electroluminescent device of Example 1, except for the fact that, instead of the layer of PBD, there was deposited a layer of 3.5-bi(4-ter-butyl-phenyl)-4-phenyl-triazole (TAZ).

The device thus obtained, which has an active surface of 0.07 cm², was tested under laboratory conditions (i.e., with a temperature of between 20° C. and 24° C. and with a humidity of between 55% and 65%) and revealed an electromagnetic emission in the green.

1. An organic electroluminescent device (1) based upon emission of exciplexes or electroplexes, said organic electroluminescent device (1) basically including an anode (2), a cathode (3), a first layer (4), which comprises at least one organic material for transporting positive charges (5) and is set in contact with the anode (2), and a second layer (6), which comprises at least one organic material for transporting negative charges (7) and is set in contact with said cathode (3) and with said first layer (4), said organic material for transporting negative charges (7) and said organic material for transporting positive charges (5) being capable to form between them exciplexes or electroplexes.

2. The device of claim 1, wherein said anode (2) is substantially transparent.

3. The device of claim 2, and comprising a transparent substrate (9) set in contact with said anode (2).

4. The device of claim 2, wherein said anode (2) comprises indium and tin oxides (ITOs).

5. The device of claim 3, wherein said transparent substrate (9) is a sheet of glass.

6. The device of claim 1, wherein said organic material for transporting negative charges (7) has a first ionization potential, and said organic material for transporting positive charges (8) has a second ionization potential, said first ionization potential being higher by at least 0.7 electronvolts than the second ionization potential.

7. The device of claim 1, wherein said organic material for transporting negative charges (7) has a first electronic affinity, and said organic material for transporting positive charges (5) has a second electronic affinity, said first electronic affinity being higher by at least 0.4 electronvolts than said second electronic affinity.

8. The device of claim 1, wherein said material for transporting positive charges (5) is substantially made up of a tertiary aromatic amine for transporting positive charges, said tertiary aromatic amine satisfying the structural formula: 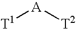
in which T¹ and T² represent, each independently of the other, a tertiary amine, and in which A represents an aryl group.

9. The device of claim, wherein T¹ and T² represent, each independently of the other, a tertiary amine that satisfies a structural formula chosen in the group consisting of: 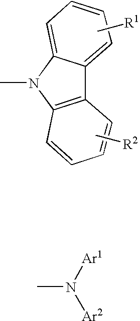
in which R¹ and R², represent, each independently of the other, one chosen from among:
an alkyl group,
an alcohol group, or
an atom of hydrogen.
in which Ar¹ and Ar² represent, each independently of the other, an aryl group.

10. The device of claim, wherein Ar¹ and Ar² represent, each independently of the other, a functionality that satisfies a structural formula chosen in the group consisting of: 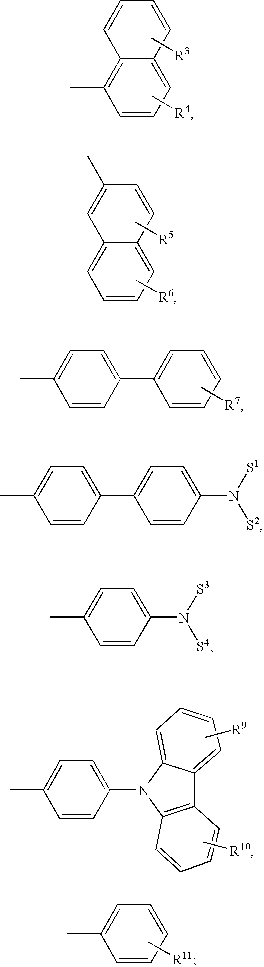
in which R³, R⁴, R⁵, R⁶, R⁷, R⁹, R¹⁰ and R¹¹ represent, each independently of the others, one chosen from among:
an alkyl group,
an alcohol group, or
an atom of hydrogen;
and in which S¹, S², S³ and S⁴ represent, each independently of the others, a functionality chosen in the group consisting of: 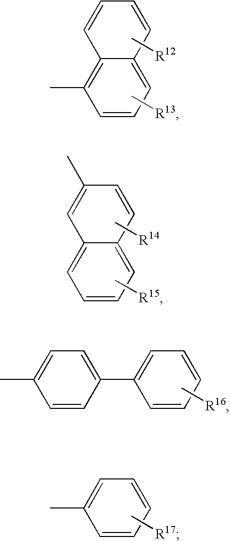
in which R¹², R¹³, R¹⁴, R¹⁵, R¹⁶, and R¹⁷ represent, each independently of the others, one chosen from among:
an alkyl group,
an alcohol group, or
an atom of hydrogen.

11. The device of claim 8, wherein A represents an aryl group that satisfies a structural formula chosen in the group consisting of:

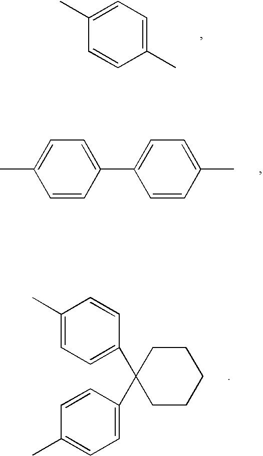

12. The device of claim 8, wherein said tertiary aromatic amine is chosen in the group consisting of
4,4′,4″-tri(N-3-methylphenyl-N-phenyl-amino)-triphenylamine (M-TDATA),
4,4′,4″-tri(N,N-diphenyl-amino)-triphenylamine (TDATA), or
4,4′,4″-tri(carbazol-9-yl)-triphenylamine (TCTA).

13. The device of claim 1, wherein said material for transporting negative charges (7) is essentially made up of a heterocyclic compound that satisfies one chosen from among the structural formulas: 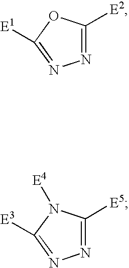
in which E¹, E², E³, E⁴ and E⁵ represent, each independently of the others, an aryl group.

14. The device of claim 13, wherein E¹, E², E³, E⁴ and E⁵ represent, each independently of the others, a substituent that satisfies one chosen from among the following structural formulas: 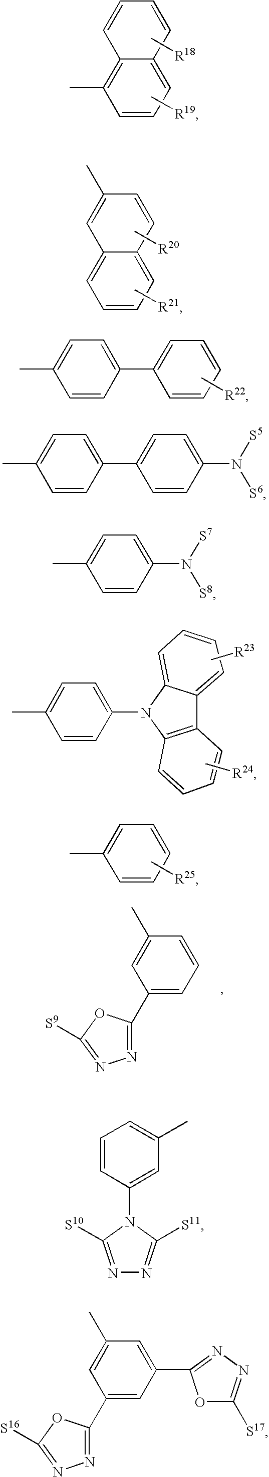 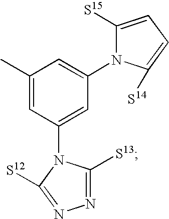
in which R¹⁸, R¹⁹, R²⁰, R²¹, R²², R²³, R²⁴, and R²⁵ represent, each independently of the others, one chosen from among:
an alkyl group,
an alcohol group, or
an atom of hydrogen;
and in which S⁵, S⁶, S⁷, S⁸, S⁹, S¹⁰ S¹¹, S¹², S¹³, S¹⁴, S¹⁵, S¹⁶ and S¹⁷ represent, each independently of the others, a functionality that satisfies one chosen from among the following structural formulas: 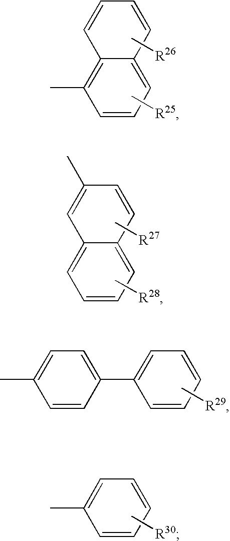
in which R²⁵, R²⁶, R²⁷, R²⁸, R²⁹, and R³⁰ represent, each independently of the others, one chosen from among:
an alkyl group,
an alcohol group, or
an atom of hydrogen.

15. The device of claim 13, wherein said heterocyclic compound is chosen in the group consisting of:
3,5-bi(4-ter-butyl-phenyl)-4-phenyl-triazole (TAZ), or
3-(4-diphenylyl)-4-phenyl-5-ter-butylphenyl-1,2,4-triazole (PBD).

16. The device of claim 1, in which said cathode (3) comprises a metal chosen in the group consisting of:
alkaline metals, or
alkaline-earth metals.

17. A method for the fabrication of an organic electroluminescent device (1) based upon emission of exciplexes or electroplexes, said method including basically the steps of: depositing on an anode (2) a first layer (4) comprising at least one organic material for transporting positive charges (5); depositing on said first layer (4) a second layer (6) comprising an organic material for transporting negative charges (7); positioning on said second layer (6) a cathode (3), said organic material for transporting negative charges (7) and said organic material for transporting positive charges (5) being capable to form between them exciplexes or electroplexes.

18. The device of claim 17, wherein said organic material for transporting positive charge (5) and of said organic material for transporting negative charge (7) are chosen so as to obtain selectively a pre-set wavelength of the emission of exciplexes or electroplexes.

19. The device of claim 17, and comprising the step of positioning said anode (2) on a transparent substrate (9).

20. The device of claim 17, wherein said organic material for transporting negative charges (7) has a first ionization potential and said organic material for transporting positive charges (5) has a second ionization potential, said first ionization potential being higher by at least 0.7 electronvolts than said second ionization potential.

21. The device of claim 17, wherein said organic material for transporting negative charges (7) has a first electronic affinity and said organic material for transporting positive charges (5) has a second electronic affinity, said first electronic affinity being higher by at least 0.4 electronvolts than said second electronic affinity.

22. The device of claim 17, wherein said material for transporting positive charges (5) is substantially made up of a tertiary aromatic amine for transporting positive charges, said tertiary aromatic amine satisfying the structural formula: 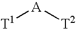
in which T¹ and T² represent, each independently of the other, a tertiary amine, and in which A represents an aryl group.

23. The device of claim 17, wherein said material for transporting negative charges (7) is substantially made up of a heterocyclic compound that satisfies one chosen from among the structural formulas: 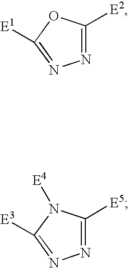
in which E¹, E², E³, E⁴ and E⁵ are, each independently of the others, an aryl group.
